(19) United States
(12) Patent Application Publication
(10) Pub. No.: US 2007/0057388 A1
(43) Pub. Date: Mar. 15, 2007

(54) Apparatus for enhancing the aesthetic appearance of contained liquids

(76) Inventor: Brock S. McCabe, Malibu, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/227,337

(22) Filed: Sep. 15, 2005

(51) Int. Cl. B01F 3/04

(52) U.S. Cl. 261/81; 261/DIG. 7

(57) ABSTRACT

An apparatus for enhancing the aesthetic appearance of contained liquids using an ultrasonic frequency transducer in either direct contact with the outer surface of a liquid container or through an intermediate layer of a gel, solid material or combination thereof. The intermediate layer may also include a sealed chamber of liquid. In a preferred embodiment, the apparatus is configured as an advertising device in a beverage dispenser commonly referred to as a “soda vending machine” to attract attention to the dispenser of those in proximity thereto. The inventive concept disclosed herein can also be advantageously exploited for the marketing of other beverages such as beer, wine, liquor, bottled water and the like such as in retail stores as shelf items or in special aisle displays. The present invention may also be utilized as a form of artistic expression or as a novelty item.

### BACKGROUND OF THE INVENTION

1. Field of the Invention

The present invention pertains generally to the advertising and artistic fields and more particularly to an apparatus for causing a contained liquid to generate gas bubbles. Such apparatus may be used in advertising/marketing such as in beverage dispensers to increase the appeal of bottled beverages. It may also be employed in artistic devices to create an aesthetically pleasing effect in a contained liquid.

2. Background Art

A principal function of the invention is to generate gas bubbles in carbonated and non-carbonated beverages, contained in closed, glass or plastic containers for the purpose of enhancing the aesthetic appeal and provide eye-catching movement in such beverages. Such beverages include varieties of sugar and non-sugar sweetened “soda-pop,” beer, champagne, tonic water, wine, liquor, sparkling wine as well as many others.

The invention produces bubbles in beverages using a piezoelectric or electromagnetic-based transducer driven at ultrasonic frequencies of 18 kHz or greater. The type of transducer is similar to those commonly used in ultrasonic cleaner machines, of the bath and probe type.

The general concept of intentionally causing a contained beverage to bubble is not new. In U.S. Pat. No. 5,880,359, Kono et al describe a container inspecting apparatus which employs ultrasonic transducers to vibrate a liquid in which there is a container having an effervescent beverage therein. If the container is not properly sealed, the vibration transmitted through the liquid and to the container apparently causes the beverage to effervesce. If the beverage is properly sealed within the container, there is supposed to be no effervescing. However, the Applicant hereof has discovered that even well sealed beverage containers, when subjected to an ultrasonic frequency vibration, will permit the contained beverage to bubble. Moreover, Applicant has discovered that this characteristic can be aesthetically useful for advertising/marketing of beverages and in artistic presentations, preferably when configured in a manner which obviates the non-sealed, liquid vibration transmission medium.

Previously, beverages in sealed containers have been excited to bubble while placed in a bath of running water or oil. This was acceptable because the containers were present in a carefully monitored industrial or production line environment. However, when the bubblers are to be placed in a store display, outdoor display, or in a vending machine, it would be undesirable to have to connect the unit to running water. In the case of a non-flowing liquid bath, the liquid level would have to be refilled as it was splashed, evaporated, or carried off as residue on a beverage container being removed. Furthermore, a liquid bath can spill on a store floor or inside of a vending machine creating a dangerous situation. In addition, if the particular beverage in a bubbler unit was to be sold, the oil or water would have to be wiped off the container bottom first. Therefore, it is desirable to replace such a bath with a gel, solid, and/or sealed liquid that has no problems with splashing, spilling, or excessive residue.

This also facilitates the mounting of the bubbler onto the vertical, back-side of the beverage container, allowing the entire front surface to be unobstructed to the customer.

### SUMMARY OF THE INVENTION

Thus the present invention comprises an apparatus for enhancing the aesthetic appearance of contained liquids using an ultrasonic frequency transducer in either direct contact with the outer surface of a liquid container or through an intermediate layer of a gel or solid material or combination thereof. The intermediate layer may also include a sealed chamber of liquid. In a preferred embodiment, the apparatus is configured as an advertising device in a beverage dispenser commonly referred to as a “soda vending machine” to attract attention to the dispenser of those in proximity thereto. Of course, the inventive concept disclosed herein can also be advantageously exploited for the marketing of other beverages such as beer, wine, liquor, bottled water and the like such as in retail stores as shelf items or in special aisle displays or the like as will be fully explained hereinbelow. The present invention may also be utilized as a form of artistic expression or as a novelty item.

The visual effect of the bubbling can be enhanced through lighting as well as by positioning the beverage container at angles that maximize the flow of bubbles across the inside surface of the container. Furthermore, motion or light sensors can be used to activate the device and thus conserve energy.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is an elevational view of a preferred embodiment beverage display using the invention for a single container;

FIG. 2 is an elevational view of a beverage dispenser or soda vending machine in which the embodiment of FIG. 1 is employed;

FIG. 3 is an illustration of an artistic application of the invention;

FIG. 4 is an illustration of yet another artistic application of the invention; and

FIG. 5 is still another illustration of an artistic version of the invention.

### BRIEF DESCRIPTION OF PREFERRED EMBODIMENTS

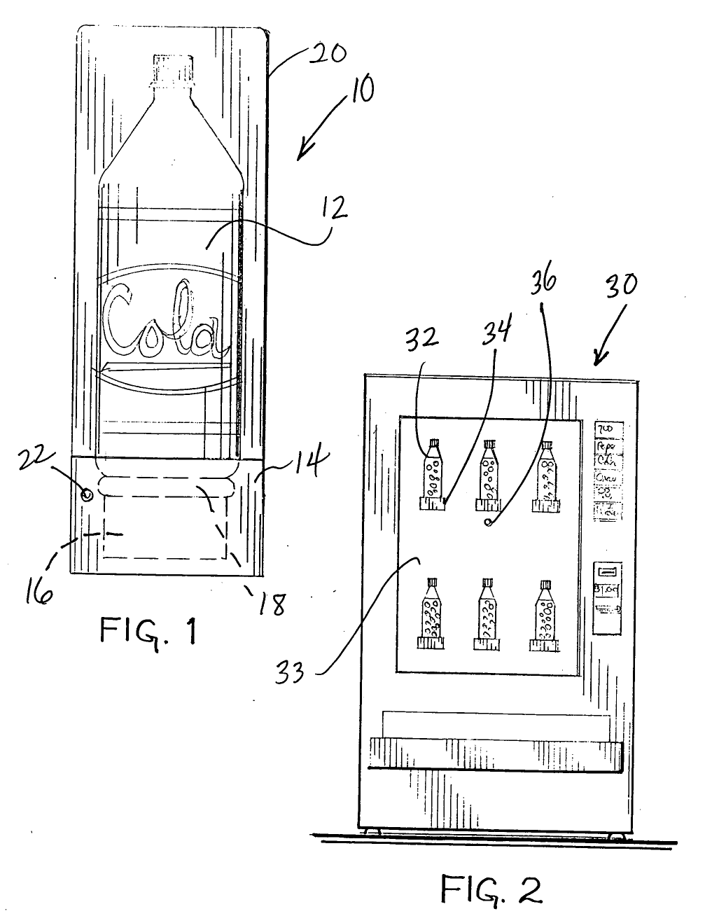

Referring to the accompanying drawings and initially to FIGS. 1 and 2, it will be seen that a first embodiment 10 comprises a beverage container 12 mounted in a chamber 14. Hidden from view within chamber 14 is an ultrasonic transducer 16. This unit may be of a conventional type used in ultrasonic cleaners or the like including piezoelectric or electromagnetic transducers capable of generating vibratory motion at 18 kHz and higher frequencies. Transducer 16 couples its ultrasonic output energy to the beverage container 12 through an acoustic coupling material 18 which may be in the form of a gel or solid with or without a sealed liquid chamber or combination thereof. Container 12 preferably rests on coupling material 18 so that the vibratory energy is readily transferred into the container and the beverage therein. The container may also rest directly on the ultrasonic transducer.

A lighted background 20 may be used advantageously to accent the bubbles generated in the beverage by the ultrasonic transducer 16. An optional sensor 22 that is responsive to motion or light, may be employed to conserve energy and extend the life of the transducer by activating the transducer only in response to nearby motion or reflected light. The beverage container 12 may be positioned so that it is slightly tilted either forward toward the observer or in the opposite direction to optimize the bubble effect and the visual impression of the stimulated bubbles on the observer.

FIG. 2 illustrates a vending machine 30 such as for dispensing bottles of a selected beverage (i.e., sodas, juices, water, et cetera). Contained within a display area 33 are a number of beverage containers 32 each mounted in a corresponding chamber 34 having the ultrasonic transducer and acoustic coupling material or layer of FIG. 1. A single motion (or light) sensor 36 may optionally activate all of the various transducers in response to nearby motion, for example, to conserve energy.

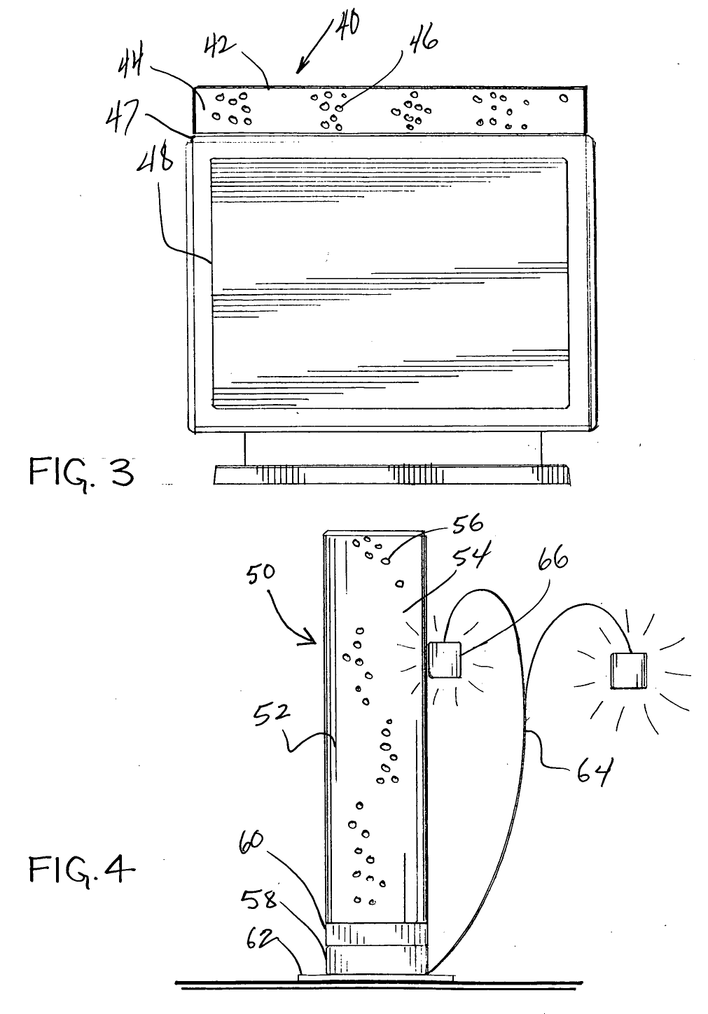

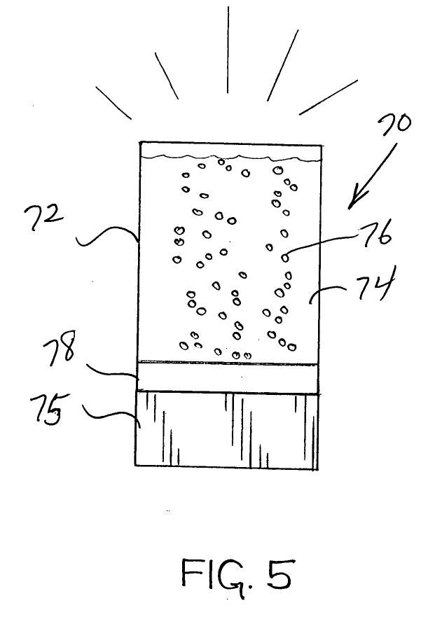

Artistic embodiments of the present invention are shown in FIGS. 3-5. In FIG. 3 a low profile embodiment 40 is shown. This version provides a container 42 having a liquid 44 therein (which may be clear or tinted). The container 42 rests on a transducer 47, which acting either directly or through an acoustic coupling material or layer, generates bubbles 46 in the liquid 44. The entire apparatus is configured as a relatively flat unit for support on an underlying surface such as a television 48 or other piece of furniture or shelf or the like. Embodiment 50 of FIG. 4 is a stand-alone unit which has a tall cylindrical container 52 having a liquid 54 sealed therein to produce bubbles 56. Container 52 rests on a transducer 58 and a coupler 60, both of which are mounted on a suitable base 62. An attached light fixture 64 has at least one light 66 positioned near or in contact with the container 52 to accentuate the bubbles 56 and their movement in liquid 54. A more compact high profile embodiment 70 is shown in FIG. 5 and comprises a clear container 72, sealed liquid 74 forming bubbles 76 in response to transducer 75 and coupler 78. A light (not shown) may be integrated into the transducer or into the coupler to transmit light up through the liquid 74.

Having thus disclosed various illustrative embodiments of the invention, it will now be apparent that various alternative configurations of the invention may be perceived based upon the unique characteristics described herein. By way of example, the artistic embodiments of the invention may employ containers of rather unusual and convoluted shape as part of an elaborate sculpture. Moreover, elongated tubular configurations may be employed in aquariums to stimulate the fish therein or to provide attractive visual effects. Accordingly, the scope hereof is not to be limited by the content of the disclosure but instead by the appended claims and their equivalents.

I claim:

1. An apparatus for enhancing the aesthetic appearance of beverages; the apparatus comprising:
an ultrasonic transducer generating vibratory energy at an ultrasonic frequency;
an acoustic coupling in contact with said transducer;
at least one transparent container having a beverage therein, said container being at least partially immersed in said coupling so that said vibratory energy is transferred into said container for generating gas bubbles in said beverage.

2. The apparatus recited in claim 1 wherein said acoustic coupling comprises a gel.

3. The apparatus recited in claim 1 wherein said acoustic coupling comprises a solid.

4. The apparatus recited in claim 1 wherein said container is sealed.

5. The apparatus recited in claim 1 wherein said acoustic coupling comprises a sealed chamber having a liquid therein.

6. The apparatus recited in claim 1 further comprising a vending machine having a chamber visible from the exterior of said machine, said transducer, said coupling and said container being positioned within said chamber for displaying said generated gas bubbles.

7. An advertising apparatus for beverage vending machines and retail point of purchase displays; the apparatus comprising:
an ultrasonic transducer generating vibratory energy at an ultrasonic frequency;
an acoustic coupling in contact with said transducer;
at least one transparent container having a beverage therein, said container being at least partially in contact with said coupling so that said vibratory energy is transferred into said container for generating gas bubbles in said beverage.

8. The apparatus recited in claim 7 wherein said acoustic coupling comprises a gel.

9. The apparatus recited in claim 7 wherein said acoustic coupling comprises a solid.

10. The apparatus recited in claim 7 wherein said container is sealed.

11. The apparatus recited in claim 7 wherein said coupling comprises a sealed chamber having a liquid therein.

12. The apparatus recited in claim 7 further comprising a vending machine having a chamber visible from the exterior of said machine, said transducer, said coupling and said container being positioned within said chamber for displaying said generated gas bubbles.

13. The apparatus recited in claim 7 further comprising a sensor responsive to motion in proximity of said apparatus for activating said transducer for a selected period of time in response to sensed motion.

14. The apparatus recited in claim 7 further comprising at least one light source positioned relative to said container for enhancing the appearance of said gas bubbles.

15. An apparatus for generating gas bubbles in a liquid in a container for altering the appearance of the liquid; the apparatus comprising:
an ultrasonic transducer generating vibratory energy at an ultrasonic frequency; and
a coupling transmitting said vibratory energy to said container, said coupling being selected from a group of acoustic energy transmissive materials consisting of a gel, a solid, and a liquid within a sealed chamber.

16. A method of generating gas bubbles in a liquid sealed in a container; the method comprising the steps of:
a) providing an ultrasonic transducer for generating vibratory energy at a frequency no less than 18 kHz; and
b) coupling said vibratory energy to said container to stimulate the production of gas bubbles in said liquid.
